(19) United States
(12) Patent Application Publication
(10) Pub. No.: US 2008/0271032 A1
(43) Pub. Date: Oct. 30, 2008

(54) Data Processing Network

(75) Inventor: Graham Twaddle, Kilcreggan (GB)

Correspondence Address: PATRICK W. RASCHE;ARMSTRONG TEASDALE LLP, ONE METROPOLITAN SQUARE, SUITE 2600, ST. LOUIS, MO, 63102-2740, US

(73) Assignee: CORPORATE MODELLING HOLDINGS PLC, London (GB)

(21) Appl. No.: 11/914,855

(22) PCT Filed: May 22, 2006
(86) PCT No.: PCT/GB06/01879

§ 371 Date: Jul. 15, 2008

(30) Foreign Application Priority Data
May 20, 2005 (GB) 0510327.0

(51) Int. Cl. G06F 9/50; G06F 9/46

(52) U.S. Cl. 718/104; 718/105

(57) ABSTRACT

A grid type network comprising a grid controller for receiving data in the form of a queue from a database. The grid controller is arranged to divide the data into a plurality of batches and dispatch the batches between a plurality of terminals which may be registered with the grid controller. Each terminal is registered on the basis that it contains a processing unit which is usually in an idle state. The terminals are also provided with processing logic related to the processing to be carried out on the batches. The plurality of terminals perform the processing on the batches and on completion, the database is updated with processed data.

The present invention relates to data processing. In particular, the invention relates to the handling of data processing in a network such as a local area network.

A computer network is typically formed of a client server architecture, where a network access server is in communication with a plurality of client computers. The network access server is a central main frame server which stores all the applications which are to be run by the clients and details of the clients. Such a server will require advanced specifications in order to handle the multi-tasking in a computer network comprising a large number of users of typically 30,000 users. Moreover, the server requires regular maintenance and replacement of the server costs a huge amount.

An object of the present invention is to overcome the problems with the above mainframe system and provide an efficient and cost effective system to provide similar services to a mainframe system.

From a first aspect, the present invention provides a grid type network comprising a plurality of terminals each comprising a central processing unit (CPU) and each in communication with a grid control means arranged to monitor and control processes sent to each terminal.

Each terminal in the grid type network represents a client terminal of a normal computer network. This type of network configuration obviates the need for a mainframe server of the type used in conventional large-scale networks. It follows that the use of normal client terminals as the servers of the network therefore removes the costs associated with a mainframe server and utilises the various elements of the network in a more efficient manner.

Each terminal can perform any number of tasks and the number of tasks assigned to it will depend on the idle CPU power available from the terminal.

The network uses dynamic load balancing techniques which is controlled by the grid control means. In this connection, the tasks are balanced between the plurality of terminals such that one particular terminal is not overrun with tasks.

In order that the present invention is more readily understood embodiments thereof will be described by way of example with reference to the accompanying drawings in which:

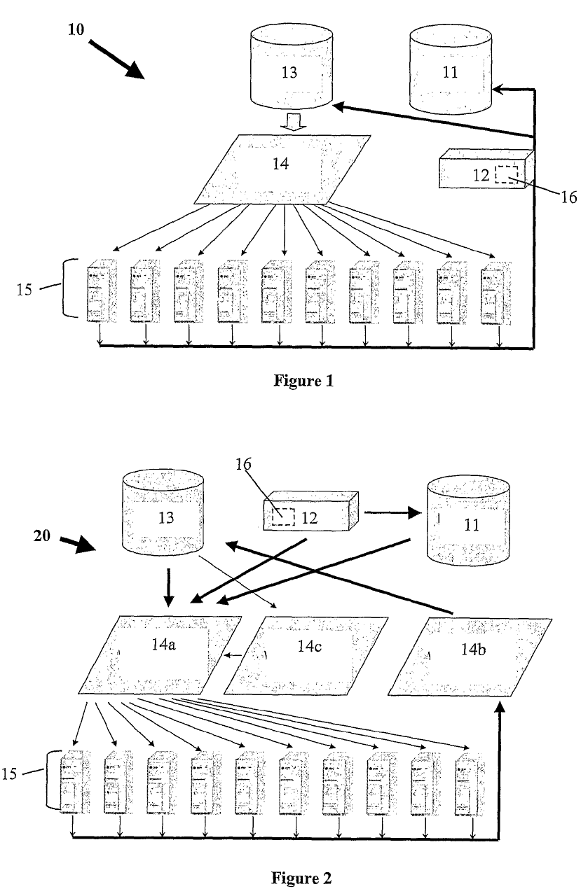

FIG. 1 shows a schematic diagram of a first embodiment of the present invention; and

FIG. 2 shows a schematic diagram of a second embodiment of the present invention.

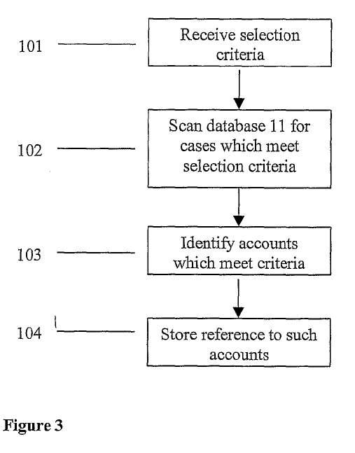

FIG. 3 shows a flow diagram showing the steps carried out by an initiator which may be provided in either FIG. 1 or FIG. 2.

The invention is based on the replacement of a central mainframe server which is expensive to purchase and maintain with a plurality of normal desktop terminals each containing a processor in a grid type network arrangement. It will be appreciated that laptop computers or any other form of computer comprising a processor may be utilised.

One type of mainframe system is arranged with a central mainframe server which stores all the programs utilised by the network and a plurality of “dumb” terminals which log onto the central server and run programs directly from the mainframe server. The “dumb” terminals do not have a processor or any storage means and only have an input device such as a keyboard and a display for displaying any information relating to the program being run on the mainframe server. In this type of arrangement, any processing that is required will occur at the mainframe server rather than at the terminal itself.

Another type of system is a network-distributed system where a terminal is a typical workstation in an organisation and includes a processor for processing data at the terminal itself. A central server stores information relating to users of the terminals (such as login details) and loads any user specific settings onto the particular terminal when the user logs onto the network. Each user terminal contains any number of programs and can run programs independent of the central server. However, certain programs may be downloaded from the server as and when required and do not necessarily have to be stored on the terminal. It is this type of system that the present invention is particularly suited to.

Typically, a very small percentage of total processor power available in a terminal is ever used at any one time. The present invention uses the processor power not being used in the terminal to carry out processes allocated to it. Two embodiments will now be described in detail.

According to a first embodiment as shown in FIG. 1 there is provided a data processing system 10 comprising a database 11, a logic control unit 12, a workflow storage unit 13, a grid controller 14, and a plurality of terminals 15.

The database 11 stores any type of data and is typically found in an organisation. For example, the data may relate to user bank accounts in a financial organisation, and the database would contain all such accounts as cases.

The logic control unit 12 stores processing logic relating to a plurality of processes which are to be performed on the data stored in the database.

The workflow storage unit 13 receives data from the database 11 for which processing is to be carried out and stores the data in a queue.

The grid controller 14 is arranged to receive the queue data from the workflow storage unit 13 and divide it into a plurality of batches. It therefore follows that each batch comprises data from the data queue. Furthermore it will allocate each batch to the plurality of terminals 15. It will be appreciated that the each batch is not necessarily of the same size and thus one batch may contain more data than another. For example in a financial system where a queue of user accounts require processing, the grid controller will divide the data into a plurality of batches which may or may not comprise the same number of user accounts which require processing.

The grid controller 14 monitors the status of the dispatched batches and after a time delay, decides whether to interrogate the plurality of terminals in communication thereto in order to determine whether the data allocated to each has been processed.

The plurality of terminals 15 each comprise an application program (not shown) to enable it to communicate with the various parts of the system 10. One of the terminals 15 will receive the allocated fragment from the grid controller 14 and carry out processing by retrieving the processing logic from the logic control unit 12. The grid controller 14 is capable of determining which user terminal to allocate a batch to on the basis of registration of a terminal 15 with the grid controller 14 and/or by monitoring the CPU of each terminal 15 on a continuous or periodic basis to determine whether the CPU is idle, fully occupied or partially occupied and thus estimates available processing power for each terminal for use in the grid.

The grid controller 14, when sending the batch data to a terminal 15, will record the time at which it is set and calculate the total time it should take for the terminal to carry out the process.

On completion of the processing of the allocated batch, the terminal 15 will send a message to the grid controller 14 to indicate that it has completed the processing of its allocated fragment and is ready to accept further batches. It will send the processed batch data to the logic control unit 12 which updates the database 11 with the processed data and updates the data queue in the workflow storage unit 13. The terminals 15 are connected to the logic control unit 12 via a bus line configuration.

If no message is received by the grid controller 14 from the terminal 15 to indicate that the processing has been completed, the grid controller 14 will either wait longer, resend to the terminal or re-allocate the batch to another terminal 15 which is registered as idle with the grid controller 14. The choice taken by the grid controller 14 will depend on the predetermined condition which has been manually set or may be made automatically by the grid controller 14 on the basis of, for example, the size of the batch i.e. if no response has been received in relation to a small batch it will be resent to another terminal without waiting any longer.

It will be appreciated that it may not be necessary for the terminal 15 to send a flagging message to indicate completion of the allocating processing. Instead the grid controller 15 can monitor the terminal to which it has sent a batch on a continuous or periodic basis and determine itself whether a process has been completed. Therefore a flagging by the terminal may not be required. However it will be apparent that both the flagging by the terminal and the periodic monitoring may be utilised in the system to determine whether an allocated task has been completed.

In order to prevent duplication of the data uploaded to the database, the database contains a record and will be aware of whether it has already received data relating to a certain batch from another terminal 15. Any duplicated data will be discarded.

A second embodiment of the invention is shown in FIG. 2. Features in common with the first embodiment are represented by the same reference numerals.

In this system 20, the grid controller is arranged to dispatch the logic required to carry out the processes as well as the batches to the registered terminals 15.

The grid controller comprises three components: a dispatcher 14a, an implementer 14b, and a monitor 14c.

The dispatcher 14a receives queue data which requires processing from the workflow database 13. The queue data is randomly divided into batches and creates a plurality of packages ready for sending to the registered terminals. The dispatcher 14a obtains the logic required to process the data from the logic control unit 12 and adds this to each package. Each package is then distributed to the allocated terminal 15 for processing.

The implementer 14b is arranged to receive the processed data from the terminal 15 once it has carried out the allocated processing. It then updates the database 11 with the processed data and also updates the work flow storage unit 13.

The monitor 14c is arranged to monitor the status of the registered terminals 15 and assess whether the terminals 15 are running. If they are not, the monitor 14c causes the batch of the terminal 15 which is not running to be sent to another terminal by sending an appropriate message to the dispatcher 14a to resend the package.

The implementer 14b ensures that data is not duplicated in the database 11 as it will be aware of the data which has passed through it by any appropriate manner for example, by means of a memory which stores a record.

This embodiment may not be appropriate for terminals which are not permanently connected to the grid controller and more suited for remote terminals such as laptops.

In addition, it may be possible for a remote laptop to login to the grid controller via the internet and therefore download package from the grid controller and report back to the grid controller when processing is complete. Moreover, the grid controller may be in continuous or periodic communication with the remote terminal over the internet connection so as to monitor the status of the processing.

Accordingly, the arrangement provided in both embodiments enables data to be processed in an efficient manner by including a grid controller which monitors and dispatches data to computers which are arranged in a network.

It will be appreciated that both embodiments may be combined to provide the two systems in one network.

Furthermore, although the various features of the embodiments are shown in the figures as separate elements, it will be appreciated that they may be combined in a single unit. For example, the database 11, logic control unit 12, workflow database 13 and grid controller 14 may be combined in a single unit and still maintain its required functionality.

It is to be emphasised that in both embodiments each process is part of a much larger process to be performed on the batches of data. The larger process is divided into a plurality of discrete steps and one or more of these discrete steps may be dispatched to a terminal. Accordingly, it is not necessary for one of the discrete steps to have been performed on all of the data before performing a subsequent discrete step. The division of the data and process into smaller batches provides a workflow system which can dynamically manage a large amount of data allocating work across many separate terminals arranged in a grid formation.

It is apparent that there is minimal user interaction and only a few initialisation steps are required by the user. Firstly the user identifies the larger process. The larger process defines the steps which need to be carried out and the order in which these need to be done to successfully complete the process. The frequency of the process can then be defined by the user i.e how often it needs to be done, and this could be daily, weekly, monthly etc. The user can then define how many terminals 15 or which sections of the grid are to be used for the process. Accordingly, the sequential list of steps of the larger process can be changed into a parallel processing structure so as to improve the efficiency of the system.

In a process which is particularly suited to the present invention, there is defined a start symbol which shows the start of a process, at least one task to define some types of action, a flow which represents the flow between the tasks, and an end symbol which indicates the end of the process.

The database 11 contains a plurality of cases and a state machine is used to identify where in an overall process a case or the cases actually is/are. Accordingly, each case which is being processed has a state associated with it. Each case would begin in the state of awaiting processing and end in either a state of completed processing or failed processing.

The processing is not necessarily performed on all data contained in the database 11 and is dependent on an event which causes a process to begin for example, the event may occur cyclically and in the case of a financial organisation the event could be the application of daily interest. The occurrence of the event would not identify the cases which require processing, only the type of processing which is to occur.

Another embodiment will now be described which relates to a further modification which can be provided to the basic arrangements of FIGS. 1 and 2 and is shown as a dashed box 16 in FIGS. 1 and 2. In order to determine the cases which require processing from the database 11, an initiator 16 is provided which is used to select from all the possible data, a subset of the data that is required to be placed in the start state of the state machine. In this embodiment the initiator 16 is a module which lies in logic control unit 12 and serves to cooperate with the database 11 in order to determine the cases on the database 11 which require processing on the basis of certain selection criteria and flagging such cases by applying a unique reference. This reference would be stored in order to easily identify that the case requires processing.

In the case of financial organisation, the initiator 16 will have the capability of accepting input of selection criteria and determine the cases from the database 11 that require say daily interest to be applied. For example, the initiator 16 will only select user bank accounts from the cases stored in the database 11 which are eligible for daily interest and not monthly interest for example. This could be determined by the initiator 16 by analysing certain fields of the data relating to each account stored on the database 11 and only flag accounts which have a certain field highlighted identifying that the account is eligible for daily interest. Other accounts may have a field highlighted identifying that the account is eligible for monthly interest only and thus this account would not be flagged by the initiator on this occasion in light of the selection criteria which has been pre-selected by the user.

Furthermore, the initiator 16 could also refer to the current balance of each account stored in the database to determine whether or not interest is to be added such that if an account is not in credit then no interest is applied. Moreover, if the selection criteria has been made to also flag the accounts which are not in credit then instead of flagging that interest is to be applied, another type of flag is applied to indicate that a charge is to be applied for those accounts which are overdrawn. This will occur if the selection is made by the user for such action to be taken in addition to flagging accounts for calculation of daily interest. By carrying out this analysis, the initiator 16 can determine through a single instance of scanning accounts stored in the database that two different types of calculation (i.e. daily interest or overdrawn charge) are to be performed.

When it comes to assigning batches to terminals 15, the flags can be referred to by the grid controller 14 and the correct processing can be carried out. This also allows for certain terminals 15 to be assigned with carrying out the different types of calculations (either daily interest or overdrawn charge) and only batches which require that particular calculation being sent to the relevant terminal that has been assigned to perform that calculation. This is possible due to the initiator 16 being capable of receiving selection criteria and determining on the basis of this information which accounts require processing.

It will be appreciated that the initiator 16 does not need to be located in the logic control unit 12 but may be arranged on a standalone system to communicate with the database 11. Indeed, the initiator may be located in any other element of the system 10,20 which is capable of interrogating a location where the data is stored.

FIG. 3 shows a flow diagram outlining the method carried out by the initiator 16.

At a certain point in time, for example midnight, a financial organisation may be set up to perform some processing on the data relating to accounts stored in their database. The initiator 16 is provided with selection criteria which is representative of the type of process which needs to be carried out on the accounts (step 101).

A scan is then carried out on the database 11 to determine the accounts which need processing on the basis of the selection criteria. Not all the data in the database 11 may require scanning and thus the selection criteria would highlight this to allow the initiator 16 to only scan the relevant part of the database 11 if necessary (step 102).

The accounts which meet the selection criteria are identified (step 103) and a reference is stored to indicate that the account contains the data which requires processing (step 104).

With this preliminary analysis performed by the initiator 16, these instructions do not need to be provided to any other parts of the system 10, 20, such as the grid controller 14 or terminals 15 thus improving the efficiency of the system. The subsequent arrangement of data into batches and processing is carried out as outlined hereinbefore with reference to FIG. 1 or FIG. 2.

Accordingly, it is apparent that no separate agents or brokers are required by the system according to the invention. Instead, the data which requires processing is extracted from a database 11 and split from a very large queue work into a plurality of smaller queues. These smaller queues are then handed out to terminals 15 for processing.

It will be appreciated that the terminals 15 can be desktop computers, laptops computers, rack mounted servers and/or floor standing servers.

Furthermore, the terminals 15 may be heterogeneous or homogenous meaning that they will run a certain platform such as .Net for Windows, Java for Unix and the logic control unit 12 could send the correct type of code which is recognisable by the correct server. Accordingly the logic control unit 12 could have several versions of the same logic to do the same process but suitable for the particular platform being run on a terminal. This could be a NET version for terminals running Windows and a Java version for terminals running Unix.

1. A data processing system (10,20) comprising:
a data storage means (11,13) for storing data;
a data control means (14, 14a, 14b, 14c) for receiving a queue of data requiring processing from the data storage means (11,13) and for dividing the data into a plurality of datasets; and
a plurality of server terminals (15), each terminal comprising an application program arranged to accept the dataset from the data control means and processing means arranged to carry out a predetermined process on the dataset in order to generate a processed dataset;
wherein the data control means is arranged to dispatch the plurality of datasets to the plurality of server terminals and to determine whether the predetermined process has been completed on the dataset.

2. The system of claim 1 wherein the predetermined process is a sequential step taken from an overall larger process.

3. The system of claim 1 wherein the server terminals are arranged to receive the predetermined process from a logic control means (12).

4. The system of claim 1 wherein the server terminals are arranged to receive the predetermined process from the data control means.

5. The system of claim 1 wherein the terminal is arranged to provide the processed dataset to the data storage means.

6. The system of claim 1 further comprising an initiator arranged to select data in the data storage means which is to be sent to the data control means on the basis of selection criteria.

7. The system of claim 1 wherein the server terminal is a desktop computer, rack mounted server or floor standing server.

8. The system of claim 1 wherein the server terminal is a laptop computer, rack mounted server or a floor standing server.

9. A data processing method comprising the steps of:
a) receiving a queue of data from a database;
b) dividing the queue of data into a plurality of fragments;
c) dispatching a first fragment of the plurality of fragments to a first server terminal;
d) sending a predetermined process to the first server terminal;
e) carrying out the predetermined process on the first fragment;
f) determining whether the predetermined process on the first fragment is complete; and
g) updating the database with the first processed fragment data if the predetermined process is complete.

10. The method of claim 9 further comprising:
sending a first signal indicative of the completion of the processing from the server terminal after the completion of step e).

11. The method of claim 9 wherein step f) comprises:
sending a second signal to the first server terminal if the first signal is not received within a predetermined time period.

12. The method of claim 9 further comprising:
re-dispatching the one of the plurality of fragments to a second server terminal.

13. The method of claim 10, further comprising:
performing a check to establish whether the database has been updated with the first processing fragment data.

14. The method of claim 9 further comprising:
scanning the database to determine the data which requires processing on the basis of selection criteria.
